(19) United States
(12) Patent Application Publication
(10) Pub. No.: US 2005/0262957 A1
(43) Pub. Date: Dec. 1, 2005

(54) Synchronizer design

(76) Inventor: Syed T. Razzacki, Troy, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/853,450

(22) Filed: May 25, 2004

(51) Int. Cl. F16D 47/00

(52) U.S. Cl. 74/339

(57) ABSTRACT

A method for designing a synchronizer in a transmission which has a plurality of components each defined by one or more parameters is provided. The method includes selecting a first parameter having a relationship to the transmission. A second parameter is selected based off of a relationship to the first parameter. Then, the synchronizer components are designed while simulating a synchronization episode using the first and second parameters. The synchronization episode is divided into stages wherein for any given stage at least one component parameter is calculated or selected.

### FIELD OF THE INVENTION

The present invention relates to synchronizers in powertrain systems and more particularly to the design of synchronizers in powertrain systems.

### BACKGROUND OF THE INVENTION

Modern day transmissions are expected to provide performance and comfort during a gear change. In order to accomplish this task, typical transmissions include an apparatus known as a synchronizer. A synchronizer is essentially a friction clutch which synchronizes the rotational speed of the transmission output shaft with the gear that is to be engaged. Accordingly, the synchronizer provides a smooth gear change. The location and design of synchronizers within the transmission is important in order to minimize the effects of the inertia and relative speeds of the various rotating components within the transmission. Moreover, with an increasing trend towards higher engine power and higher engine speeds due to various factors (such as multiple valves per engine cylinder, etc.), there is an increasing expectation of higher or improved shifting efforts (i.e. improved performance). Concurrently, the driver still demands smooth shiftability and comfort. Performance and comfort are typically conflicting expectations which in turn require greater efficiency from the synchronizer design.

### SUMMARY OF THE INVENTION

A method for designing a synchronizer in a transmission which has a plurality of components each defined by one or more parameters is provided. The method includes selecting a first parameter having a relationship to the transmission. A second parameter is selected based off of a relationship to the first parameter. Then, the synchronizer components are designed while simulating a synchronization episode using the first and second parameters. The synchronization episode is divided into stages wherein for any given stage at least one component parameter is calculated or selected.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of an exemplary transmission having an exemplary synchronizer designed according to the principles of the present invention;

FIG. 2A is a perspective disassembled view of the exemplary synchronizer and gear designed according to the principles of the present invention;

FIG. 2B is a cross sectional view of the exemplary synchronizer designed according to the principles of the present invention

FIG. 3 is a flow chart illustrating a design method according to the principles of the present invention for designing the exemplary synchronizer illustrated in FIGS. 1, 2A, and 2B;

FIG. 4 is a free body diagram of a ball/strut and sleeve of the exemplary synchronizer of the present invention used in designing the exemplary synchronizer;

FIG. 5 is a free body diagram of a ring of the exemplary synchronizer used in designing the exemplary synchronizer;

FIG. 6 is a free body diagram of the ring tooth chamfer and the sleeve tooth chamfer of the exemplary synchronizer used in designing the exemplary synchronizer;

FIG. 7 is an exemplary nomogram illustrating a relationship between significant parameters in the design of the exemplary synchronizer;

FIG. 8A is an alternate view of the nomogram of FIG. 7 illustrating the relationship between significant parameters in the design of the exemplary synchronizer;

FIG. 8B is another alternate view of the nomogram of FIG. 7 illustrating the relationship between significant parameters in the design of the exemplary synchronizer;

FIG. 9 is a flow chart illustrating the steps in designing the exemplary synchronizer during an imaginary synchronization event;

FIG. 10 is a free body diagram of the ball and sleeve of the exemplary synchronizer used in designing the exemplary synchronizer during a first synchronization event;

FIG. 11 is a free body diagram of the ball/strut and sleeve of the exemplary synchronizer used in designing a ball/strut and sleeve detent during a second synchronization event;

FIG. 12 is an exemplary chart illustrating various ball/strut and sleeve detent angles and ring loads used in designing the exemplary synchronizer during the second synchronization event;

FIG. 13 is a free body diagram of the sleeve, strut, and ring used in designing the exemplary synchronizer during a third synchronization event;

FIG. 14 is a free body diagram of the sleeve used in calculating a clocking angle used in the design of the exemplary synchronizer during the third synchronization event;

FIG. 15 is a free body diagram of the ring blocker used in calculating a ring tooth width during a fourth synchronization event;

FIG. 16 is a free body diagram of the sleeve and ring blocker used in calculating a gap distance during the fourth synchronization event; and

FIG. 17 is a free body diagram of the sleeve, ring blocker, and gear tooth used in calculating a gap between the sleeve and the gear during a fifth and a sixth synchronization event.

### DETAILED DESCRIPTION OF THE PREFERRED EMBODIMENTS

The following description of the preferred embodiment(s) is merely exemplary in nature and is in no way intended to limit the invention, its application, or uses.

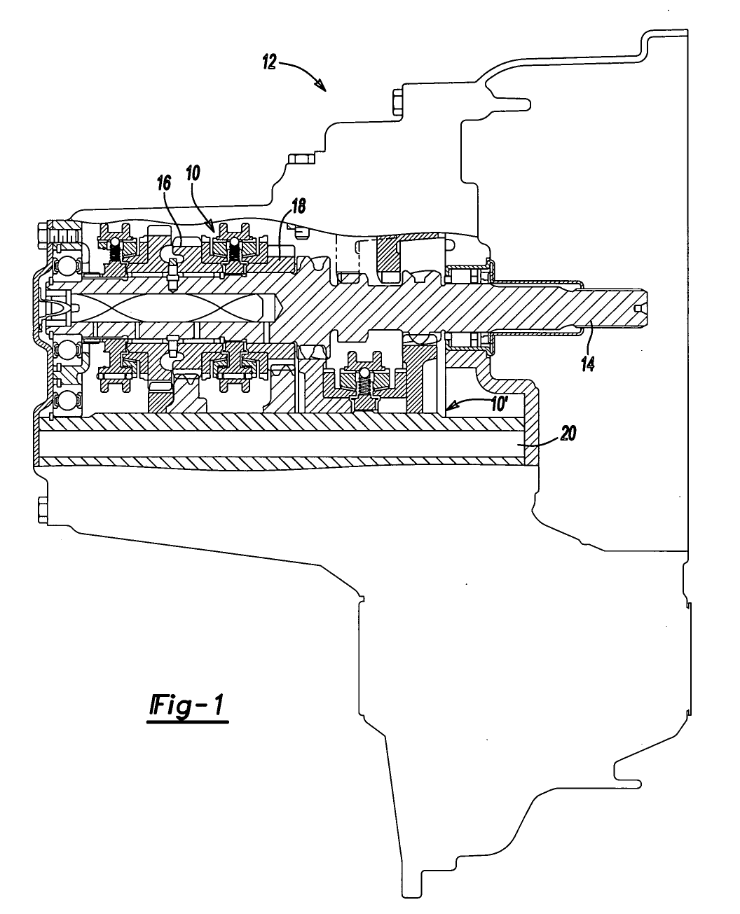

With reference to FIG. 1, there is illustrated an exemplary synchronizer 10 shown in operative association with an exemplary transmission 12. The synchronizer 10 has been designed according to a method 100 which will be described in greater detail below. The synchronizer 10 is disposed on an input shaft 14 between a first gear 16 and a second gear 18. Likewise, a substantially identical synchronizer 10′ is disposed on an output shaft 20, however, only one of the synchronizers 10 will be described. The input shaft 14 is coupled to an engine (not shown) and receives power therefrom. The output shaft 20 is in turn coupled to a drivetrain (not shown). The first and second gears 16, 18 are intermeshed with substantially similar gears on the output shaft 20 in order to transfer power from the input shaft 14 to the output shaft 20. The synchronizer 10 acts to synchronize the rotational speed of the first and second gears 16, 18.

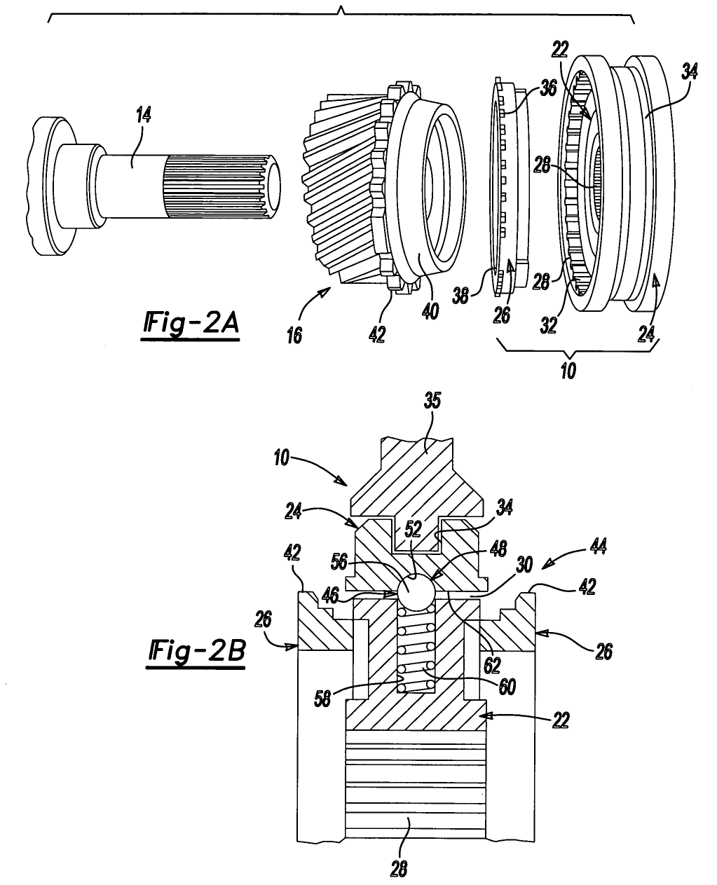

Turning now to FIGS. 2A and 2B, the synchronizer assembly 10 generally includes a hub 22, a sleeve 24, a ball/strut 56, a spring 60, and a blocker ring 26. The hub 22 includes splines 28 on an inner diameter thereof for engagement with the input shaft 14 (FIG. 1). The hub 22 further includes external splines 30 located along an outer diameter thereof as best seen in FIG. 2B. The sleeve 24 is disposed about the hub 22 and is moveable relative thereto into and out of engagement with the first and second gears 16, 18 (FIG. 1) in order to synchronize the rotation of the first and second gears 16, 18 with the rotation of the input shaft 14. Specifically, the sleeve 24 includes internal splines 32 adapted to engage the external splines 30 of the hub 22. However, the sleeve 24 is movable relative to the hub 22 in a direction of the splines 30, 32 and parallel to the longitudinal axis of the input shaft 14. To that end, the sleeve 24 includes an external annular groove 34 adapted to receive a shift fork 35 to move the sleeve 24 into and out of engagement with the first and second gears 16, 18.

The blocker ring 26 is disposed between the sleeve 24 and each of the first and second gears 16, 18. Accordingly, only the blocker ring 26 between the sleeve 24 and the first gear 16 will be described, it being understood that the description applies equally to the second gear 18. The blocker ring 26 includes external blocker teeth 36 and has a conical inner bore 38. The blocker ring 26 is carried on a cone portion 40 extending axially from the first gear 16. The external blocker teeth 36 are engaged by the internal splines 32 on the sleeve 24 as the sleeve 24 is moved into and out of engagement with the first gear 16. At the same time, the blocker ring 26 is moved relative to the cone portion 40 on the first gear 16 such that the conical inner bore 38 of the blocker ring 26 engages the cone portion 40 to begin synchronization of the first gear 16 and such that clutch teeth 42 of the first gear 16 are aligned with the internal splines 32 on the sleeve 24 to fully synchronize the rotation of the first gear 16 with the input shaft 14.

With specific reference to FIG. 2B, the synchronizer 10 further includes a retaining mechanism 44 for indexing the synchronizer sleeve 22 into and out of engagement with the adjacent gears 16, 18. The detent mechanism 44 includes at least one, but preferably a plurality of, retaining mechanisms 46. Similarly, the detent mechanism 44 includes at least one, but preferably a plurality of, detent pockets 48 disposed internally on the synchronizer sleeve 24 and corresponding to each retaining mechanism 46. Preferably, the detent mechanism 44 includes three retaining mechanisms 46 and three detent pockets 48 corresponding to each of the retaining mechanisms 46. Each pair of corresponding retaining mechanisms 46 and detent pockets 48 are equally spaced relative to an adjacent pair of corresponding retaining mechanisms 46 and detent pockets 48.

Each of the detent pockets 48 has an annular groove 52 disposed therebetween corresponding to a neutral position. The retaining mechanisms 46 include a ball 56 which is disposed between the hub 22 and the synchronizer sleeve 24 and disposed into engagement with the annular groove 52 on the detent pocket 48. Alternatively, a strut may be used interchangeably with the ball 56.

The retaining mechanism 46 further includes a slot 58 extending radially inward from the outer radial surface of the hub 22 and a coiled spring 60 disposed within the slot 58 and between the hub 22 and the ball 56 to urge the ball 56 into engagement with the annular groove 52.

Preferably, each of the balls 56 of the retaining mechanism 46 is receivable in the annular groove 52 of the detent pockets 48 to positively hold the synchronizer sleeve 24 in the neutral position. As the synchronizer sleeve 24 is actuated by the shift fork 35, the balls 56 are depressed against the force of the coiled spring 60 and ride against lands 62 on the sleeve 24. The detent mechanism 44 allows the sleeve 24 to move into and out of engagement with adjacent gears 16, 18 to synchronize the rotation of the adjacent gears 16, 18 with the rotation of the input shaft 14, while providing a detent force to urge the sleeve 24 into a neutral position when synchronization is complete.

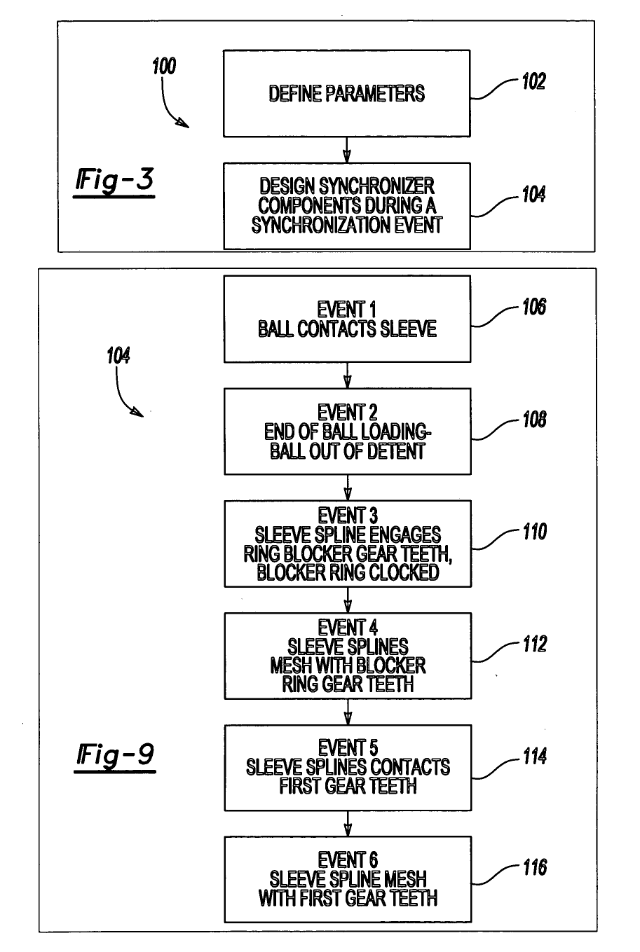

Turning now to FIG. 3, the method 100 of designing the synchronizer 10 will now be described. The method 100 begins by defining primary parameters at step 102. This includes defining a break through load (BTL), a cone torque, and an index torque. The BTL is the amount of resultant axial force due to applied force at the sleeve 24 and the detent load needed to move the blocker ring 26 into a blocker position such that conical surface of blocker ring 26 engages the conical surface of gears 16 and 18. The cone torque is the amount of torque generated when the conical inner bore 38 of the blocker ring 26 engages the cone portion 40 on a gear 16, 18. The index torque is the amount of torque generated when the sleeve 24 first engages the blocker ring 26 and the chamfers of the internal splines 32 on the sleeve 24 engage the chamfers on the external blocker teeth 36 on the blocker ring 26, thereby forcing the blocker ring 26 to slightly rotate or “index”. At step 104, the components of the synchronizer 10 are designed based on the significant parameters calculated and selected in step 102.

The BTL should continue until the chamfers of the internal splines 32 of the sleeve 24 and the chamfers of the teeth 36 on the blocker ring 26 contact and pass through. The BTL calculated in step 102 of the method 100 will now be described in detail with general reference to FIG. 4. The BTL (also known as push through load) effectively sets the blocker ring 26 into block position. The BTL should start to build as soon as the applied force at the sleeve 24 (initiated by shifting) urges the sleeve 24 to begin its movement. The BTL should continue until the internal splines 32 of the sleeve 24 contact the gear teeth 36 on the blocker ring 26. The axial distance from sleeve internal splines 32 to the blocker gear teeth 36 contact is called “proximity”. Proximity is dealt with at greater length below. The BTL must not be reduced prior to contact between the sleeve internal splines 32 and the blocker gear teeth 36 in order to avoid unloading the blocker ring 26 too soon, thereby interrupting oil wiping action and resulting in gear clash. On the other hand, if BTL continues for a time period beyond the time of contact, ring sticking will occur thereby creating a noticeable clash.

BTL is a function of detent spring rate, ball height (or strut bump when the retaining mechanism 44 is a strut mechanism), coefficient of friction between the detent ball 56 and the sleeve 24, and the ramp angle of the annulus groove 52 in the sleeve 24. Mathematically analyzing the forces on one of the three ball detents, BTL can be calculated from the following derivations, wherein Fa is the axial load to overcome detent spring reaction, Ns is the normal force on the sleeve 24, □ is the ramp angle of the annulus groove 52 on the sleeve 24, fs is the friction force of the sleeve 24, μ is the coefficient of friction between the detent ball 56 to the sleeve 24, and Fr is the reaction force of the detent spring 60:

As shown in FIG. 4, taking the sum of forces on the sleeve 24 in x- and y-direction:
F_{A}=Nₛ Sin θ+ƒₛ Cos θ
ƒₛ=μNₛ
F_{A}=Nₛ(Sin θ+μ Cos θ) (1)

Taking the sum of forces on detent ball 56:

$${F}_{A} = {N}_{s} Sin θ + {f}_{s} Cos θ \\ = {N}_{s} Sin θ + μ {N}_{s} Cos θ \\ {F}_{R} + {f}_{s} Sin θ = {N}_{s} Cos θ \\ {F}_{R} = {N}_{s} ( Cos θ - μ Sin θ ) \qquad ( 2 )$$

Substituting for Ns from equations (1) in equation (2):

$${F}_{R} = {F}_{A} \frac{Cos θ - μ Sin θ}{Sin θ - μ Cos θ} \\ {F}_{A} = {F}_{R} \frac{Sin θ - μ Cos θ}{Cos θ - μ Sin θ} \\ = {F}_{R} \frac{μ + Tan θ}{1 - μ Tan θ} \\ BTL = 3 \times {F}_{A} = 3 \times {F}_{R} \frac{μ + Tan θ}{1 - μ Tan θ} \qquad ( 3 )$$

The magnitude of the BTL should be smaller than the axial force applied at the sleeve groove 34 during shifting. However, too low a BTL could create a clash condition. Typically, approximately 9 to 11 lbs of BTL is sufficient to start activation of the blocker ring 26.

With reference to FIG. 5, the cone torque will now be described. As the blocker ring 26 pushes axially on to the cone portion 40 of the gear, the oil is wiped out and friction force is generated in the direction of the cone angle between the cone portion 40 and the conical inner bore 38 of the blocker ring 26. The cone torque is primarily a function of the axial force applied to the sleeve 24, the cone angle, the surface coefficient of friction, and active cone diameter. Cone torque can be calculated from the following equation, wherein Tc is the cone torque, F is the axial force of the sleeve 24 due to shifting, μ_{c} is the coefficient of friction of the cone surface, R is one half the cone gage diameter, and α is the cone angle of the conical inner bore 38:

$${T}_{C} = \frac{F \times {μ}_{C} \times R}{Sin α} \qquad ( 4 )$$

The cone torque is countered by the index torque, and cone torque must be greater in magnitude than the index torque in order to “index” the blocker ring 26 and complete synchronization successfully. Accordingly the following inequality must apply, wherein Ti is the index torque:
T_{c}>Tₗ (5)

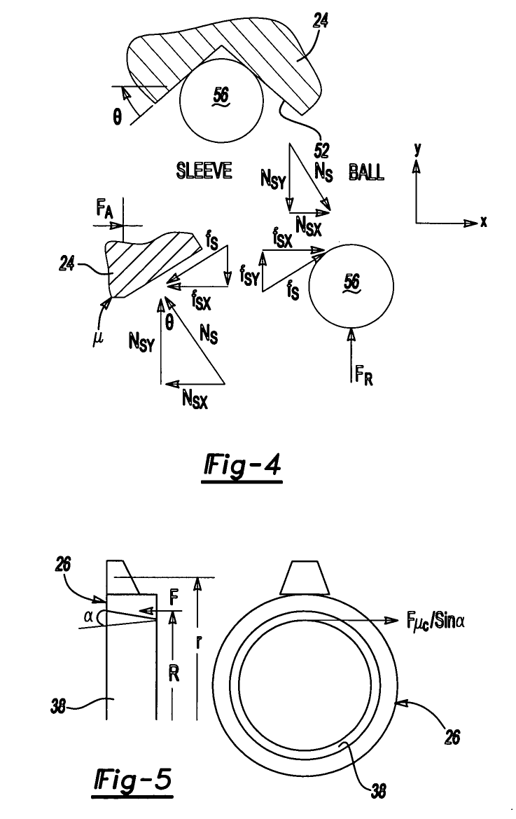

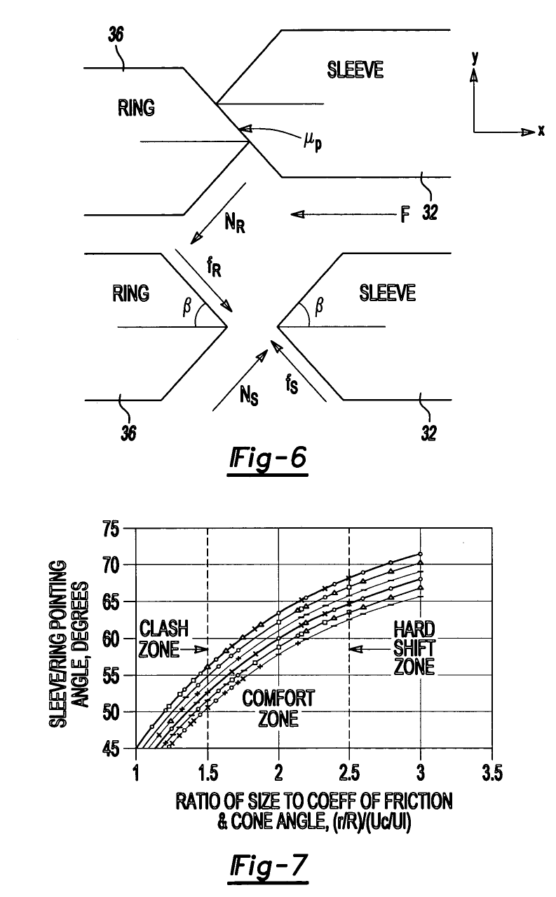

With reference to FIG. 6, the index torque will now be described. When the sleeve 24 has traversed the “proximity” distance, the sleeve internal splines 32 point contact the blocker external blocker teeth 36, and a friction force is generated between the two chamfers on each of the splines 32 and teeth 36. This friction force is in the direction of the pointing angle, thereby resulting in torque, and is known as the index torque. The index torque is a function of axial force applied to the sleeve 24, the tooth pointing angle, the pitch diameter of the blocking teeth 36, and surface coefficient of friction between the point contact surfaces of the sleeve 24 and blocker ring 26. The index torque can be calculated from the following derivations, wherein r is half the pitch diameter of the sleeve/ring teeth, β is the pointing angle of the sleeve/ring, and μₚ is the coefficient of friction between the sleeve and ring teeth:
Tₗ=Fₗ×r

Summation of forces in the x-direction on the sleeve 24:
Fₗ=Nₛ Cos β−ƒₛ Sin β=Nₛ(Cos β−μₚ Sin β)

Summation of forces in the y-direction on the sleeve 24:

$$F = {N}_{S} ( Sin β + {μ}_{p} Cos β ) \\ {N}_{S} = \frac{F}{Sin β + {μ}_{p} Cos β} \\ {F}_{I} = F \frac{Cos β - {μ}_{p} Sin β}{Sin + {μ}_{p} Cos β} \\ {T}_{I} = F \times r \frac{Cos β - {μ}_{p} Sin β}{Sin β + {μ}_{p} Cos β} \\ = F \times r \frac{1 - {μ}_{p} Tan β}{{μ}_{p} + Tan β} \qquad ( 6 )$$

In the inequality (5), substituting for T_{c} from (4) and for Tₗ from (6), produces:

$$\frac{F \times {μ}_{C} \times R}{Sin α} \geq F \times r \times \frac{1 - {μ}_{p} Tan β}{{μ}_{p} + Tan β} \qquad ( 7 )$$

Inequality (7) can be simplified to

$$Tan β \geq \frac{\frac{r}{R} - {μ}_{p} \frac{{μ}_{C}}{Sin α}}{\frac{{μ}_{C}}{Sin α} + {μ}_{p} \frac{r}{R}} \qquad ( 8 )$$

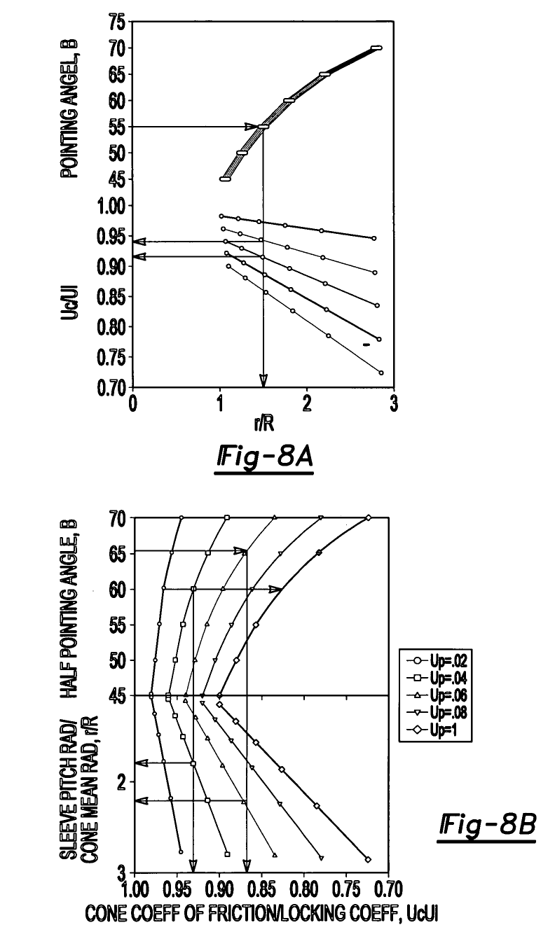

It can be observed that the inequality (8) has four interdependent significant synchronizer parameters. Nomograms are then created using inequality (8) to size, select, and verify the parameters of a synchronizer for a given application. Exemplary nomograms are shown in FIGS. 7, 8A, and 8B.

The nomogram in FIG. 7 depicts the relationship of sleeve/ring pointing angle with the size of the synchronizer, cone coefficient of friction, and cone angle for a given μₚ. This relationship resulted from the necessary condition in inequality (5) and the algorithms derived from it in inequality (8). It can be observed that the smaller the size to cone friction ratio, the smaller the pointing angle for a given μₚ, thereby resulting in clash. On the other hand, the larger the ratio the larger the pointing angle, thereby resulting in hard shift. Again, from computations based on inequalities (5) and (8), plotted in the nomogram in FIG. 7, it is clear that for a given μₚ, size to coefficient of friction ratios approximately above 2.5 could result in hard shift and approximately below 1.5 could result in clash. Accordingly, a comfortable shiftability zone lies between the two.

FIGS. 8A and 8B graphically represent the same relationship shown in FIG. 7, however, here all four significant parameters are separately charted. Accordingly, FIGS. 8A and 8B show that for a given μₚ, the greater the r/R ratio, the greater the pointing angle, thereby resulting in a hard shift. Alternatively, the smaller the r/R ratio, the smaller the pointing angle, thereby resulting in clash. Any of the three nomograms shown in FIGS. 7, 8A, and 8B are used to select the significant parameters in step 102 of the method 100.

Returning to FIG. 3, after the significant parameters have been defined using the nomograms in FIGS. 7, 8A, and 8B and inequality (8), the method 100 goes on to step 104 wherein the components of the synchronizer are designed based on the significant parameters calculated and selected in step 102.

Turning now to FIG. 9, step 104 of the method 100 involves designing the synchronizer by stepping through an imaginary synchronizer event. After selecting the physical parameters of the synchronizer, namely sleeve and blocker ring pointing angle, cone angle, cone coefficient of friction, and the size in step 102, step 104 begins the designing, dimensioning, and tolerancing of the synchronizer components. The intended objective of the design process in step 104 should be to dimension and tolerance the individual components in a manner such that, along with the selected parameters, the functional objectives are achieved satisfactorily (e.g. no clash or hard shift). The design process at step 104 includes charting the synchronization events, and iteratively dimensioning, stacking, and tolerancing for the best results. The synchronization episode has been broken up into six distinct events, including when the sleeve 24 contacts the ball 56 (Event 1) at step 106, when ball 56 loading has ended and the ball 56 is out of the annulus groove 52 (Event 2) at step 108, when the sleeve 24 engages the blocker ring 26 (Event 3) at step 110, when the sleeve 24 meshes with the blocker ring 26 (Event 4) at step 112, when the sleeve 24 first contacts the gear clutching teeth 42 (Event 5) at step 114, and finally when the sleeve 24 meshes with the gear clutching teeth 42 (Event 6) at step 116. Each of these events will be described in greater detail below.

With reference to FIG. 10, Event 1 will now be described. Event 1 is the starting point of break through load (BTL) and strut/ball loading. The components involved in Event 1 are the sleeve 24, detent strut/ball 56, and the detent spring 60. Note that a ball or strut may be used interchangeably in the design as each functions exactly the same way. Accordingly, for purposes of explanation, a strut has been illustrated in several views, it being understood that a ball may also be employed. Event 1 is pictorially illustrated in FIG. 10 and the ball loading starts at the point of first contact, and the earlier the loading begins the better. What is also called zero (0) point will be the first contact of the strut/ball on the ring. The zero point implies maximum ball length, maximum ring lug thickness, and maximum gage point offset. At the other extreme, the last contact point implies minimum ball length, minimum ring lug thickness, and minimum gage point offset.

Hence the total differences are:
Max−Min ball length=(L_{ST max}−L_{ST min})
Max−Min ring thickness=(L_{RMax}−L_{RMin})
Max−Min gage point=(G_{Max}−G_{Min})

Taking the first contact point as the zero point, the last contact will occur at a distance:
(L_{ST Max}−L_{ST Min})+(L_{Rmax}−L_{Rmin})+(G_{Max}−G_{Min}) (9)

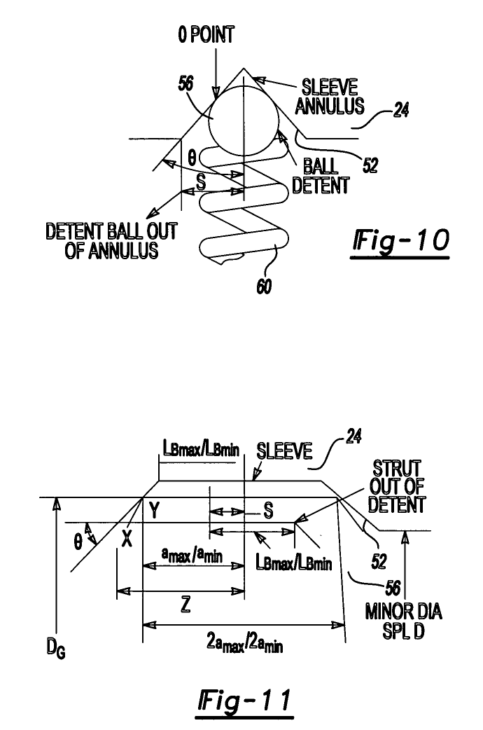

With reference to FIG. 11, Event 2 will now be described in detail. Event 2 is the end of strut/ball 56 loading and involves the sleeve 24, strut/ball 56, and the detent spring 60. The strut/ball 56 snaps back and the sleeve 24 moves on towards the blocking ring 26. It is to be noted here that the detent load is a function of the ramp angle of the sleeve annulus groove 52 and significantly influences the magnitude of BTL.

Detent profile is critical in achieving desirable BTL. Since the desirable BTL has been calculated in step 102, the task at hand is to dimension the detent profile accordingly, as shown in FIG. 11.

Computing X & Y:

$$X = \frac{Y}{tan θ}$$

$${Y}_{max} = \frac{{D}_{G} - {D}_{min}}{2}$$

$${Y}_{min} = \frac{{D}_{G} - {D}_{max}}{2}$$

For X to be minimum, ramp angle and minor diameter should be maximum, or Y minimum, hence

$${X}_{min} = \frac{{Y}_{min}}{tan {θ}_{max}} = \frac{{D}_{G} - {D}_{max}}{2 tan {θ}_{max}} \qquad ( 10 )$$

For X to be maximum, ramp angle and minor diameter should be minimum, or Y maximum, hence

$${X}_{max} = \frac{{Y}_{max}}{tan {θ}_{min}} = \frac{{D}_{G} - {D}_{min}}{2 tan {θ}_{min}} \qquad ( 11 )$$

Computing groove width Z: for Z to be minimum gage dimension a and X should be minimum,
Zₘᵢₙ=αₘᵢₙ+Xₘᵢₙ (12)

For Z to be maximum gage, dimension a and X should be maximum,
Zₘₐₓ=αₘₐₓ+Xₘₐₓ (13)

The distance strut out of detent S can be found as follows:
Sₘₐₓ=Zₘₐₓ−L_{B min} (14)
Sₘᵢₙ=Zₘᵢₙ−L_{B max} (15)

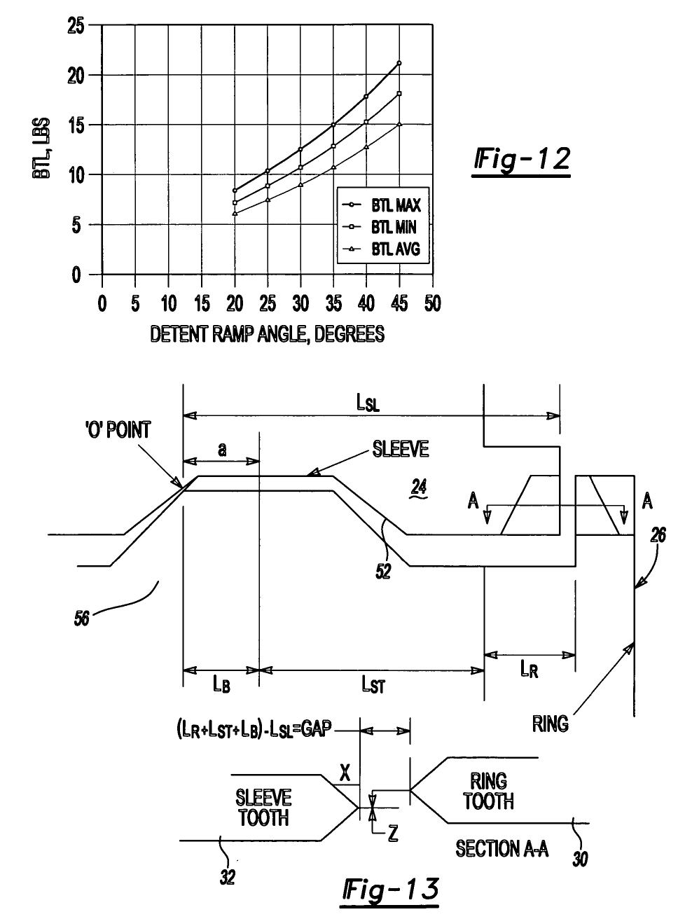

Equations (10) through (15) can be used to design the detent profile for a reasonable detent load to achieve the desired BTL. The sleeve groove 52 ramp angle contributes significantly to the detent load and to the BTL, and, as such, it is illustrated in FIG. 12. It can be observed that a ramp angle of 30 degrees for a given application will yield the desired BTL.

With reference to FIG. 13, Event 3 will now be described in detail. Components involved in Event 3 include the sleeve 24, blocker ring 26, the cone portion 40, and the conical inner bore 38. In Event 3, for the sleeve 24 point to hit the blocker ring 36 point as quickly as possible, the gap between them should be at a minimum. The minimum gap is obtained with maximum ring width, maximum ball, maximum gage point offset at ‘0’ point condition. Similarly, the maximum gap can be obtained with minimum ring width, minimum ball, and minimum gage point offset. The gap between the sleeve tooth pointing and ring tooth pointing is shown in FIG. 13, section A-A. The gap between sleeve tooth pointing and ring tooth pointing is called “proximity”, as noted above, and is equal to the following:
(L_{R}+L_{ST}+L_{B})−L_{SL} (16)

If sleeve and ring teeth have rake angle, then using trigonometry, L_{R} will increase by a fraction and L_{SL} will diminish by a fraction, thereby affecting the “proximity” by a fraction as well.

During Event 3, as soon as the sleeve pointing contacts the ring pointing, the blocker ring 26 starts to clock and “indexes” with the oncoming sleeve 24. The clocking angle is a function of the widths of the lug integral to the ring and slot width in the hub. The lug and the slot widths should be dimensioned adequately while minimum and maximum clocking angles should be calculated to insure that there is enough time for BTL to develop. Moreover, if the time is too long, the ring 36 would take too much time to set for the oncoming sleeve 24.

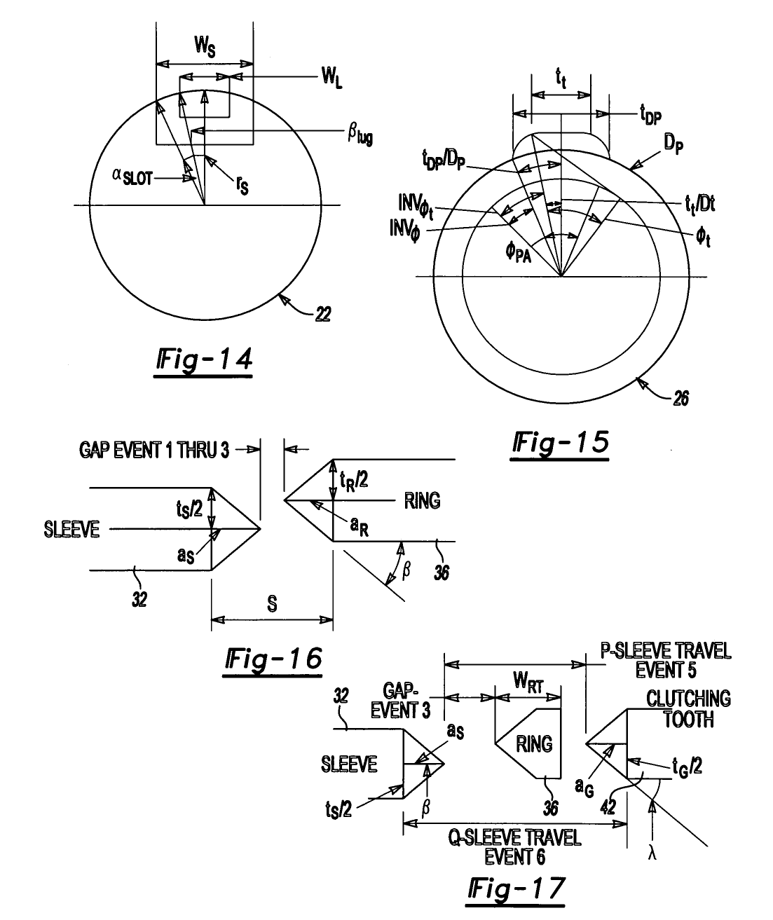

The clocking angle is calculated by applying trigonometry using the lug and slot widths and the radius at the lug, as shown in FIG. 14. Maximum clocking is obtained from maximum slot width, minimum lug width, and minimum radius.

$$\begin{matrix}Sin {α}_{SLOT} = \frac{{W}_{S}}{2 \times {r}_{S}} , \\ {α}_{SLOT} = {Sin}^{- 1} \frac{{W}_{S}}{2 \times {r}_{S}} & ( 17 ) \\ Sin {β}_{LUG} = \frac{{W}_{L}}{2 \times {r}_{S}} , \\ {β}_{LUG} = {Sin}^{- 1} \frac{{W}_{L}}{2 \times {r}_{S}} & ( 18 )\end{matrix}$$

Clocking angle
ψ=α_{SLOT}−β_{LUG} (19)

From experience, the clocking angle should be approximately less than 4 but greater than 3 degrees (4 [symbol] ψ [symbol] 3), and the lug and slot width should be dimensioned accordingly.

Turning back to FIG. 13, Section A-A, the dimension Z between the tooth points is an arc. The angle between the center of a sleeve tooth and the center of a space is as follows:

$$\begin{matrix}\frac{360}{N + N} = \frac{180}{N} \\ AL ( 180 / N ) = \frac{180}{N} \times {r}_{R} & ( 20 ) \\ AL ( ψ ) = ψ \times {r}_{R} & ( 21 )\end{matrix}$$

In equations (20) and (21) the angles (180/N) and ψ are in radians. For x to be small the pointing angle should be maximum,

$$tan β = \frac{z}{x} \\ z = AL ( \frac{180}{N} ) - AL ( ψ ) \qquad ( 22 )$$

Turning to FIG. 15, Event 4 will now be described in which the ring tooth width is calculated. During Event 4, the sleeve 24 is engaging the ring blocker 26. Given the pressure angle, the ring tooth thickness and the circular space width of the sleeve splines 32 can be calculated. Obtaining four values, maximum and minimum for each, they can be compared to determine the combination of tolerances at which the ring tooth thickness to sleeve space width would have positive or negative clearance. The combination of tolerances can be selected that provide desirable fit and that would be feasibly manufacturable.

Using the ring outer diameter (Dₜ) and tooth width at the pitch diameter (t_{Dp}), two minimum and two maximum values of ring tooth width are calculated. The ring tooth width can be calculated by applying the following equation:

$$\frac{{t}_{t}}{{D}_{t}} = \frac{{t}_{DP}}{{D}_{P}} + INV ϕ - INV {ϕ}_{t} , or \\ {t}_{t} = {D}_{t} ( \frac{{t}_{DP}}{{D}_{P}} + INV ϕ - INV {ϕ}_{t} ) \qquad ( 23 )$$

Using the equation (23), sleeve spline space width can be calculated that would yield four values, two maximums and two minimums. By comparing the values of ring tooth width with the sleeve spline space width, the combination of tolerances can be assessed that yield positive running clearance.

Having calculated sleeve tooth space width, the tooth width can be calculated as follows:

$${t}_{( tooth + space )} = 1 tooth + 1 space = \frac{π {D}_{t}}{{N}_{T}} \qquad ( 24 )$$

The sleeve space width has already been calculated, as noted above, accordingly the sleeve tooth width can be computed as follows:
t_{S}=t_{(tooth+space)}−t_{space} (25)

Finally, the distance traveled by the sleeve pointing chamfer from zero point to the ring pointing chamfer is then stacked, with reference to FIG. 16, as follows:

$$\begin{matrix}\begin{matrix}tan β = \frac{{t}_{R}}{2 \times {a}_{R}} \\ = \frac{{t}_{S}}{2 \times {a}_{S}} \\ = \frac{{t}_{R} + {t}_{S}}{2 ( {a}_{R} + {a}_{S} )}\end{matrix} \\ Or , {a}_{R} + {a}_{S} = \frac{{t}_{R} + {t}_{S}}{2 \times tan β} & ( 26 ) \\ \begin{matrix}S = GAP + {a}_{S} + {a}_{R} \\ = GAP + \frac{{t}_{R} + {t}_{S}}{2 \times tan β}\end{matrix} & ( 27 )\end{matrix}$$

Therefore, for minimum distance traveled by sleeve in Event IV,
Sₘᵢₙ=GAPₘᵢₙ+α_{R min}+α_{S min} (28)

For Sₘᵢₙ, the minimum GAP from Event 3 and the values of t_{R} and t_{S} are used for the conditions assigned for the minimum values in Event 4. Similarly, for Sₘₐₓ, the maximum GAP from Event 3 and the values t_{R} and t_{S} are used for the conditions assigned for maximum values in Event 4.

With reference to FIG. 17, Event 5 will be described. During Even 5, the sleeve tooth point contacts the clutching tooth point. Here again, dimensions are stacked in order to calculate the distance traveled by the sleeve 24 from zero point to meet the clutching tooth point. The distance the sleeve 24 pointing has to travel from zero point to meet the clutch tooth pointing can be computed by stacking up the GAP in Event 3 along with the blocker ring 26 and clutching tooth dimensions as follows, wherein for Pₘᵢₙ the dimension L_{SL} is maximum and all other dimensions are minimum, and for Pₘₐₓ the dimension L_{SL} is minimum and all other dimensions are maximum:
P=Δ+G+L_{RW}+L_{ST}+L_{B}−L_{SL}
P=Δ+G+W_{RT}+GAP (29)

With continued reference to FIG. 17, Event 6 will now be described. During Event 6 (the final event), when the sleeve 24 travels from the zero position, and its chamfer passes the gear clutching tooth chamfer to complete the gear engagement. During this event the blocker ring 26 is completely unloaded and freely gets back to zero position marking the end of cone torque. The total distance traveled by sleeve pointing from zero position to go past the gear clutching tooth chamfer can be computed as follows:

$$\begin{matrix}Q = P + {a}_{S} + {a}_{G} & ( 30 ) \\ tan β = \frac{{t}_{S}}{2 \times {a}_{S}} , or {a}_{S} = \frac{{t}_{S}}{2 \times tan β} & ( 31 ) \\ tan λ = \frac{{t}_{G}}{2 \times {a}_{G}} , or {a}_{G} = \frac{{t}_{G}}{2 \times tan λ} & ( 32 )\end{matrix}$$

Substituting values from equations (31) and (32) in equation (30):

$$Q = P + \frac{{t}_{S}}{2 \times tan β} + \frac{{t}_{G}}{2 \times tan λ} \qquad ( 33 )$$

As described above, the method 100 can be used to establish accurate relationships among the synchronizer significant physical parameters (e.g., size, coefficient of friction, cone torque, cone angle, index torque, and sleeve/blocker ring pointing angle) to allow an intelligent synchronizer design. By using nomograms developed herein, significant physical parameters may have their relationships instantly and easily defined. Finally, the six distinct events of synchronization design help to dimension and tolerance the physical parameters as selected above to achieve the prime objective of smooth transition from one gear to the other.

The description of the invention is merely exemplary in nature and, thus, variations that do not depart from the gist of the invention are intended to be within the scope of the invention. Such variations are not to be regarded as a departure from the spirit and scope of the invention.

1. A method for designing a synchronizer in a transmission, the synchronizer having a plurality of components each defined by one or more parameters, the method comprising:
selecting a first parameter having a relation to the transmission;
selecting a second parameter based off of a relationship to said first parameter;
designing the synchronizer components while simulating a synchronization event using the first and second parameters, the synchronization event divided into stages wherein for any given stage at least one component parameter is calculated or selected.

2. The method of claim 1, wherein the first parameter includes a ratio of size of the synchronizer to a coefficient of friction and cone angle within the synchronizer.

3. The method of claim 1, wherein the second parameter includes an angle within the synchronizer.

4. The method of claim 1, wherein the stages relate to positions of the components of the synchronizer at discrete time periods during the synchronization event.

5. The method of claim 4, wherein the stages further include any forces acting on the components of the synchronizer at each discrete time period.

6. A method for designing a synchronizer in a transmission, the synchronizer having a hub, a sleeve, and a blocker ring, the sleeve having a plurality of pointed teeth, the blocker ring having a plurality of pointed teeth for engagement with the pointed teeth of the sleeve, the method comprising:
designing a portion of the blocker ring;
selecting an angle for the points on the teeth on each of the sleeve and the blocker ring based on the designed portion of the blocker ring; and
designing the hub, the remaining portions of the sleeve, and the remaining portions of the blocker ring while simulating a synchronization event, the synchronization event divided into stages wherein for any given stage at least a portion of one of the hub, sleeve, and blocker ring is designed.

7. The method of claim 6, wherein designing a portion of the blocker ring includes selecting a coefficient of friction and a cone angle.

8. The method of claim 6, wherein the stages relate to positions of the hub, sleeve, and blocker ring at discrete time periods during the synchronization event.

9. The method of claim 8, wherein designing the hub, sleeve, and blocker ring during the synchronization event includes a stage when a detent mechanism on the hub first contacts the sleeve.

10. The method of claim 9, wherein designing the hub, sleeve, and blocker ring during the synchronization event includes a stage when the detent mechanism on the hub is no longer engaging the sleeve.

11. The method of claim 10, wherein designing the hub, sleeve, and blocker ring during the synchronization event includes a stage when the sleeve engages the blocker ring and the blocker ring is clocked.

12. The method of claim 11, wherein designing the hub, sleeve, and blocker ring during the synchronization event includes a stage when the sleeve fully meshes with the blocker ring.

13. The method of claim 12, wherein designing the hub, sleeve, and blocker ring during the synchronization event includes a stage when the sleeve first contacts a gear within the transmission.

14. The method of claim 13, wherein designing the hub, sleeve, and blocker ring during the synchronization event includes a stage when the sleeve fully meshes with the gear.
